(19) United States
(12) Patent Application Publication
(10) Pub. No.: US 2026/0220879 A1
(43) Pub. Date: Jul. 30, 2026

(54) GENERATING A THREE-DIMENSIONAL (3D) SCENE REPRESENTATION

(71) Applicant: QUALCOMM Incorporated, San Diego, CA (US)

(72) Inventors: Georgi DIKOV, Amsterdam (NL); Alin-Eugen DONDERA, Amsterdam (NL); Mohsen GHAFOORIAN, Diemen (NL)

(21) Appl. No.: 19/208,473

(22) Filed: May 14, 2025

Related U.S. Application Data
(60) Provisional application No. 63/750,198, filed on Jan. 27, 2025.

(51) Int. Cl. G06T 15/20; G06T 7/11; G06T 7/50

(52) U.S. Cl. CPC G06T 15/205; G06T 7/11; G06T 7/50; G06T 2207/20081; G06T 2207/20084; G06T 2210/56

(57) ABSTRACT

Systems and techniques are described herein for generating a three-dimensional (3D) scene representation. For instance, a method for generating a 3D scene representation is provided. The method may include processing image data representing a scene to generate an instance map, wherein the instance map includes pixel identifiers for pixels of the image data that represent objects in the scene; projecting, based on a pose associated with the image data, 3D-point identifiers from a 3D representation of the scene to an image plane to generate a projected instance map; reassigning pixel identifiers of the instance map based on the projected instance map to generate a reassigned instance map; modifying the 3D representation of the scene based on a depth map associated with the image data; and modifying at least one 3D-point identifier to the 3D representation of the scene based on the reassigned instance map.

### CROSS-REFERENCE TO RELATED APPLICATIONS

This application claims the benefit of U.S. Provisional Application No. 63/750,198, filed Jan. 27, 2025, which is incorporated herein by reference in its entirety.

### TECHNICAL FIELD

The present disclosure generally relates to a three-dimensional (3D) scene-representation. For example, aspects of the present disclosure include systems and techniques for generating a 3D scene-representation.

### BACKGROUND

Three-dimensional (3D)-reconstruction (3DR) techniques may generate 3D representations (e.g., 3D models) of objects, scenes (e.g., a room, an interior of a building, an outdoor environment) and/or people. Some 3DR techniques may generate a 3D model (e.g., a point-cloud model, a voxel model, or a mesh-based model) of a scene based on images and depth-maps of objects, scenes, or people.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating a three-dimensional (3D) scene representation. According to at least one example, a method is provided for generating a 3D scene representation. The method includes: processing image data representing a scene to generate an instance map, wherein the instance map includes pixel identifiers for pixels of the image data that represent objects in the scene; projecting, based on a pose associated with the image data, 3D-point identifiers from a 3D representation of the scene to an image plane to generate a projected instance map; reassigning pixel identifiers of the instance map based on the projected instance map to generate a reassigned instance map; modifying the 3D representation of the scene based on a depth map associated with the image data; and

modifying at least one 3D-point identifier to the 3D representation of the scene based on the reassigned instance map.

In another example, an apparatus for generating a 3D scene representation is provided that includes at least one memory and at least one processor (e.g., configured in circuitry) coupled to the at least one memory. The at least one processor configured to: process image data representing a scene to generate an instance map, wherein the instance map includes pixel identifiers for pixels of the image data that represent objects in the scene; project, based on a pose associated with the image data, 3D-point identifiers from a 3D representation of the scene to an image plane to generate a projected instance map; reassign pixel identifiers of the instance map based on the projected instance map to generate a reassigned instance map; modify the 3D representation of the scene based on a depth map associated with the image data; and modify at least one 3D-point identifier to the 3D representation of the scene based on the reassigned instance map.

In another example, a non-transitory computer-readable medium is provided that has stored thereon instructions that, when executed by one or more processors, cause the one or more processors to: process image data representing a scene to generate an instance map, wherein the instance map includes pixel identifiers for pixels of the image data that represent objects in the scene; project, based on a pose associated with the image data, 3D-point identifiers from a 3D representation of the scene to an image plane to generate a projected instance map; reassign pixel identifiers of the instance map based on the projected instance map to generate a reassigned instance map; modify the 3D representation of the scene based on a depth map associated with the image data; and modify at least one 3D-point identifier to the 3D representation of the scene based on the reassigned instance map.

In another example, an apparatus for generating a 3D scene representation is provided. The apparatus includes: means for processing image data representing a scene to generate an instance map, wherein the instance map includes pixel identifiers for pixels of the image data that represent objects in the scene; means for projecting, based on a pose associated with the image data, 3D-point identifiers from a 3D representation of the scene to an image plane to generate a projected instance map; means for reassigning pixel identifiers of the instance map based on the projected instance map to generate a reassigned instance map; means for modifying the 3D representation of the scene based on a depth map associated with the image data; and means for modifying at least one 3D-point identifier to the 3D representation of the scene based on the reassigned instance map.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example projection-based depth-estimation system, according to various aspects of the present disclosure;

FIG. 2 is a diagram illustrating an example of a scene that has been modeled as a three-dimensional (3D) sparse volumetric representation for 3D reconstruction (3DR);

FIG. 3 is a diagram illustrating an example of a hash map lookup type of volume block representation;

FIG. 4 is a diagram illustrating an example of a volume block;

FIG. 5 is a diagram illustrating an example of a truncated signed distance function (TSDF) volume reconstruction;

FIG. 6 is a diagram of an example voxel block selection algorithm for 3DR of a scene;

FIG. 7 is a diagram illustrating an example system for generating segmentation and/or instance data, according to various aspects of the present disclosure;

FIG. 8 is a block diagram illustrating an example system for generating a 3D representation, according to various aspects of the present disclosure;

FIG. 9 is a block diagram illustrating a system for generating a 3D representation, according to various aspects of the present disclosure;

FIG. 10 includes a number of visual representations of various data used in generating a 3D representation, according to various aspects of the present disclosure;

FIG. 11 is a diagram illustrating an example scenario to illustrate operations of the reassigner of FIG. 9, according to various aspects of the present disclosure;

FIG. 12 is a diagram illustrating another example scenario to illustrate operations of the reassigner of FIG. 9, according to various aspects of the present disclosure;

FIG. 13 is a flow diagram illustrating an example process for generating a 3D representation, in accordance with aspects of the present disclosure;

FIG. 14 is a block diagram illustrating an example of a deep learning neural network that can be used to perform various tasks, according to some aspects of the disclosed technology;

FIG. 15 is a block diagram illustrating an example of a convolutional neural network (CNN), according to various aspects of the present disclosure; and

FIG. 16 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, three-dimensional (3D)-reconstruction (3DR) techniques may generate 3D representations (e.g., 3D models) of objects, scenes (e.g., a room, an interior of a building, and/or an outdoor environment) and/or people. For example, a 3DR technique may generate a 3D representation of a scene including objects. As another example, a 3DR technique may generate a 3D representation of a person (e.g., a 3D avatar) or an object. Some 3DR techniques may generate a 3D model (e.g., a point-cloud model, a voxel model, or a mesh-based model) of objects, scenes, and/or people based on image and/or depth-maps captured of the objects, scenes, and/or people.

Given an input image, a neural network (e.g., a segmentation network) may predict per-pixel semantic and instance segmentation. Because such a neural network is conditioned only on a single image frame, the instance ID predictions for the same object might differ from one view/frame to another. If such frames were to be naively fused in a 3D volume, for example, by overwriting the voxels belonging to objects already in the 3D volume with new IDs from a subsequent view/frame, there would be two problems. First, the mask might be slightly shifted so not all voxels will be overwritten. Second, without any global accounting for the object IDs, there will be repetitions, such as on other objects seen in a different part of the room.

Systems, apparatuses, methods (also referred to as processes), and computer-readable media (collectively referred to herein as “systems and techniques”) are described herein for generating 3D representations. For example, the systems and techniques described herein may obtain images and/or depth-map representations and generate a 3D representation based on the images and/or depth-map representations. The systems and techniques may assign to each voxel in 3D voxel grid (or to each vertex in a 3D mesh) an object instance ID, such that voxels/vertices belonging to the same object have the same ID.

For example, the systems and techniques may process image data representing a scene (e.g., using a segmentation network) to generate an instance map. The instance map may include pixel identifiers for pixels of the image data that represent objects in the scene.

The systems and techniques may project, based on a pose associated with the image data, 3D-point identifiers from a 3D representation of the scene to an image plane to generate a projected instance map. For example, in the iterative process of generating the 3D representation of the scene, the systems and techniques may project 3D-point identifiers from the 3D representation onto an image plane based on the pose from which the image data was captured.

Additionally, the systems and techniques may reassign pixel identifiers of the instance map based on the projected instance map to generate a reassigned instance map. For example, the systems and techniques may reassign identifiers of the instance map (e.g., generated by the segmentation network) based on projected identifiers (e.g., based on the identifiers iteratively added to the 3D representation in the iterative process of generating the 3D representation).

In some aspects, the systems and techniques may modify the 3D representation of the scene based on a depth map associated with the image data. For example, in the iterative process of generating the 3D representation of the scene, the systems and techniques may modify 3D points of the 3D representation based on the depth map.

The systems and techniques may modify at least one 3D-point identifier to the 3D representation of the scene based on the reassigned instance map. For example, the systems and techniques may add a 3D point identifier to the 3D representation of the scene based on the reassigned identifiers of the reassigned instance map. As another example, the systems and techniques may modify (e.g., change) a 3D point identifier of the 3D representation of the scene based on the reassigned identifiers of the reassigned instance map.

In some aspects, the systems and techniques may generate a 3D mesh based on the 3D representation of the scene. In such cases, the 3D mesh may include 3D-mesh identifiers based on the 3D-point identifiers. In these or other aspects, the systems and techniques may generate a 3D voxel grid based on the 3D representation of the scene. In such cases, the 3D voxel grid may include voxel identifiers based on the 3D-point identifiers.

Various aspects of the application will be described with respect to the figures below.

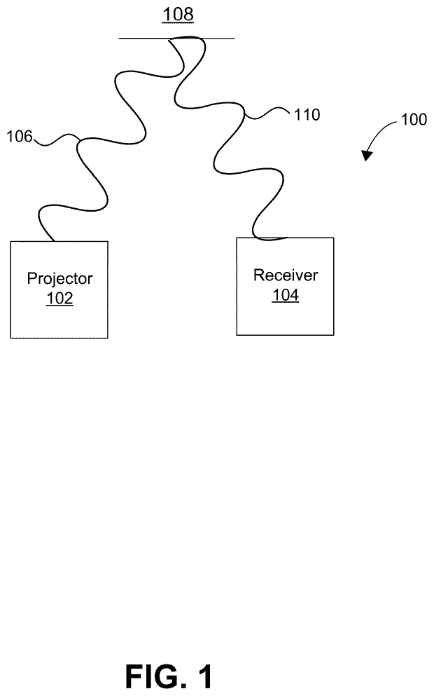

FIG. 1 is a diagram illustrating an example projection-based depth-estimation system (system 100), according to various aspects of the present disclosure. System 100 may be, or may include, for example, a light ranging and detection (LIDAR)-based system, a radio detection and ranging (RADAR)-based system, a direct time-of-flight (DToF) system, or an indirect time-of-flight (IToF) system.

As a LIDAR system, a RADAR system, or a dToF depth system, system 100 may measure a timing difference (e.g., a time of flight) between when emitted light pulse 106 is emitted by projector 102 and when reflected light pulse 110 received by receiver 104 (e.g., after emitted light pulse 106 has been reflected by object 108 in an environment). Although illustrated as spread apart in FIG. 1, projector 102 and receiver 104 may be collocated, beside one another, or interspersed with one another. As a LIDAR system, a RADAR system, or a dToF depth system, system 100 may, based on the time of flight and the speed of light, calculate a distance between the system 100 and object 108 in the environment. As used here, the term “light” may refer to any portion of the electromagnetic spectrum including, as examples, visible light, infrared (IR) light, and/or radio waves etc.

As an iToF depth camera, System 100 may measure a phase difference between emitted light pulse 106 as emitted by projector 102 and reflected light pulse 110 as received by receiver 104. System 100 may relate the phase difference to a time of flight of emitted light pulse 106 between emission and reception, based on the speed of light and the frequency of the light pulse. As an iToF depth camera, System 100 may, based on the time of flight and the speed of light, calculate a distance between system 100 and object 108 in the environment.

System 100 may emit one more light pulses into the environment and determine depth information relative to the environment. For example, projector 102 may emit one or more light pulses and receive and focus reflected light pulses onto an array of sensors of receiver 104. The array of depth sensors may include a number of independent depth sensors arranged as depth pixels. Each depth pixel may correspond to a ray between the depth pixel and the environment. For example, reflections along a given ray may be focused onto a given depth pixel. System 100 may store depth information recorded by various sensors as depth values of depth pixels of a depth map.

Additionally or alternatively, projector 102 and receiver 104 may scan the environment. For example, projector 102 may project emitted light pulse 106 into the environment at a given angle and receiver 104 may receive reflected light pulse 110 from the environment. Projector 102 may change angles, for example, scanning the environment, and receiver 104 may track reflected light pulse 110 from various angles of projector 102. System 100 may store depth information from various angles as depth values of depth pixels of a depth map.

There are a number of alternative methods for generating depth data (e.g., depth maps). Such alternatives include, as examples, depth from stereo (DFS) techniques, patterned-illumination techniques, phase-detection techniques (for example, related to phase-detection autofocus PDAF), and monocular (e.g., machine-learning-model-based) techniques. The systems and techniques may operate with depth data from any source.

As an illustrative example, a system can perform 3DR to reconstruct a 3D scene from 2D image frames (e.g., images and/or depth maps). The system can divide the scene into 3D blocks (e.g., voxels, voxel blocks, or volume blocks). For example, the system may project each voxel block onto a 2D depth frame (e.g., depth map) and a 2D image to determine the depth and/or color of the voxel block. Once all of the voxel blocks that refer to (e.g., are associated with) this depth frame and color frame are updated accordingly, the process can repeat for a new depth frame and color frame pair or set. In some cases, color integration may not be needed. For instance, some 3DR systems may operate on depth and not color. The systems and techniques described herein can apply to depth only 3DR systems and to 3DR systems that operate on depth and color. In the present disclosure, the term “3DR,” “3D reconstruction understanding,” and “3DRU,” may refer to 3D reconstruction algorithms, techniques, systems, modules, etc.

As previously mentioned, in 3DR, 3D scenes are represented using a 3D volume of points called voxel blocks, where each voxel block typically carries implicit surface information, such as in the form of a truncated Signed Distance Function (TSDF) value and a weight for depth integration. The TSDF value is a measure of distance of the voxel block from a surface, and the weight is a measure of the reliability of the TSDF value. A TSDF weight can be estimated using various approaches, such as a simple counter (e.g., a binary weight of “1” or “0”), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to “1.”

A 3DR system may use a sequence of depth maps of a scene with their corresponding six (6) degrees of freedom (DoF) poses as an input. The depth maps can be generated using deep learning (DL) algorithms, non-DL algorithms, and/or other depth estimation methods. A 3D space of the scene can be uniformly sampled along the X, Y, and Z directions. The 3D space can be divided into fixed size volumes (e.g., block volumes with a fixed number of samples).

A 3DR system may include three stages, including block selection, depth integration, and surface extraction. During block selection, blocks that have surfaces or are located close to a surface can be selected. These blocks can then be allocated into memory. In depth integration (also referred to as block integration), all voxel blocks within a block volume can be iterated over and an updated TSDF value weight can be calculated. In surface extraction, marching cubes can be used to determine triangular surfaces in the blocks.

In block selection, depth pixels can be iterated over to unproject them to a 3D space and determine where they lie within the 3D space using intrinsic and extrinsic camera parameters. Typically, a hash map is employed for block selection. A hash map is an unordered map that includes a listing of blocks (e.g., including block indices of the blocks) that have a surface. The hash map can include a corresponding counter for each of the blocks that maintains a count of the number of times depth pixels lie within the particular block. A threshold (e.g., threshold value or number) can be used to select all the blocks that have depth pixels lie within them for more than the threshold number of times. The selected blocks can then be integrated. The cache size (e.g., size of the hardware for the cache memory, which can be used to store the hash map) can depend upon the depth range, sample distances, block size, etc.

A system may generate a three-dimensional (3D) map of an environment of the system based on images of the environment. For example, volume blocks (e.g., “voxels” or “voxel blocks”) are often used to reconstruct a 3D scene from 2D images (e.g., stereoscopically-paired images obtained from a stereoscopic pair of cameras). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

A 3D reconstruction technique (“3DR”) utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four-centimeter block dimension. In some examples, for this room, the occupied voxel blocks may only be about ten to fifteen percent.

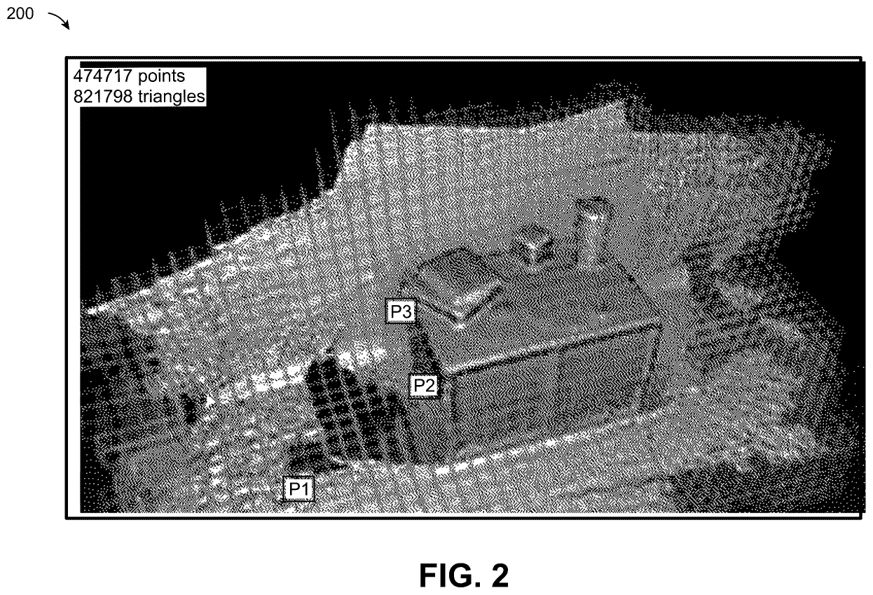

FIG. 2 is a diagram illustrating an example representation of a scene that has been modeled as a 3D sparse volumetric representation for 3DR. In particular, FIG. 2 is a diagram illustrating an example of a 3D surface reconstruction 200 of a scene modeled with an overlay of a volume grid containing voxel blocks. For 3DR, a camera (e.g., a stereo camera) may take photos of the scene from various different viewpoints and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and, in some cases, can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

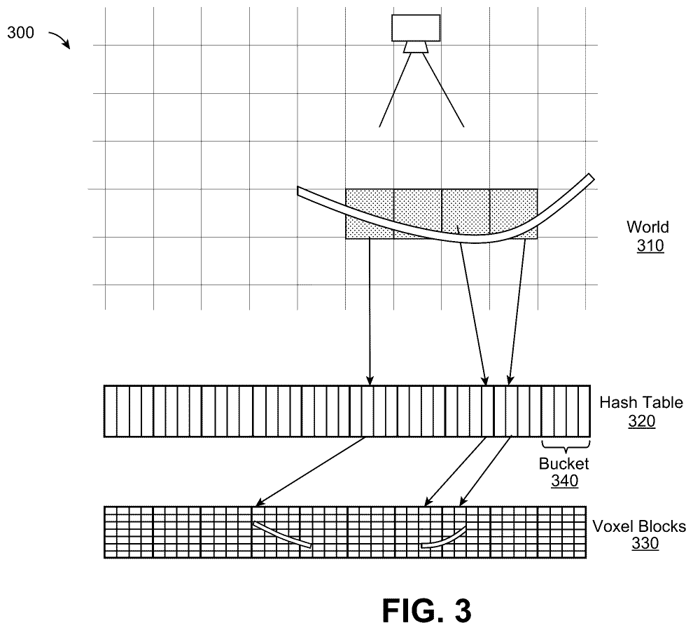

FIG. 3 is a diagram illustrating an example of a hash map lookup type of volume block representation. In particular, FIG. 3 is a diagram illustrating an example of a hash-mapping function 300 for indexing voxel blocks 330 in a volume grid. In FIG. 3, a volume grid is shown with world coordinates 310. Also shown in FIG. 3 are a hash table 320 and voxel blocks 330. In one or more examples, a hash function can be used to map the integer world coordinates 310 into hash buckets 340 within the hash table 320. The hash buckets 340 can each store a small array of points to regular grid voxel blocks 330. Each voxel block 330 contains data that can be used for depth integration.

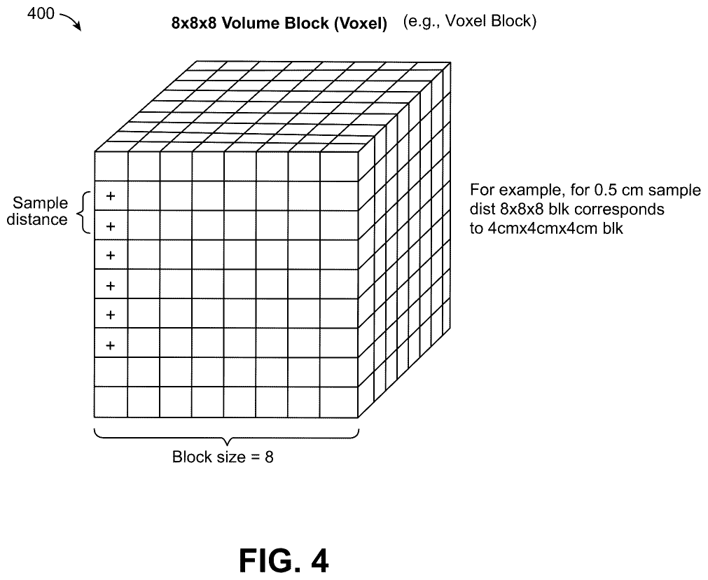

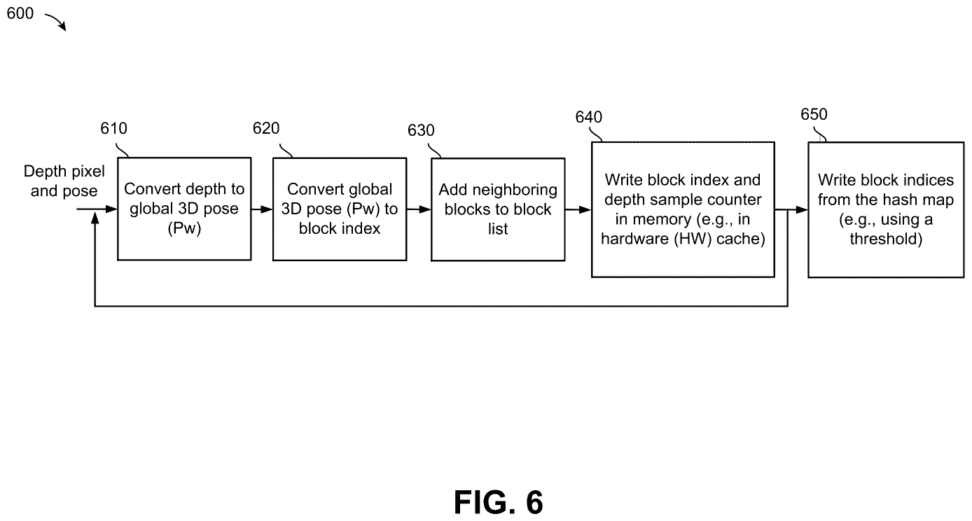

FIG. 4 is a diagram illustrating an example of a volume block (e.g., a voxel block) 400. In FIG. 4, the voxel block 400 is shown to have a block size of eight. For example, a 0.5-centimeter (cm) sample distance for an eight by eight-by-eight voxel block can correspond to a four cm by four cm by four cm voxel block. That is, the voxel block 400 includes a 3D lattice of 512 voxels, the voxels arranged so that the voxel block 400 has a width of 8 voxels, a length of 8 voxels, and a height of 8 voxels. In one or more examples, each voxel block (e.g., voxel block 400) can contain or store truncated signed distance function (TSDF) samples and a weight. In some cases, each voxel can also contain or store color values (e.g., red-green-blue (RGB) values). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [−1, 1], for example based on:

[[copy from 2500177P1 FIG. 6 or 2501114P1 text]]

$$tsdf = \{ \begin{matrix}- 1 & if d \leq - ramp \\ \frac{d}{ramp} & if - ramp < d < ramp \\ 1 , & if d \geq ramp\end{matrix} \}$$

$$sample . tsdf = ( \frac{sample . weight * sample . tsdf + tsdf}{sample . weight} )$$

A TSDF integration or fusion process can be employed that updates the TSDF values and weights with each new observation from the sensor (e.g., camera).

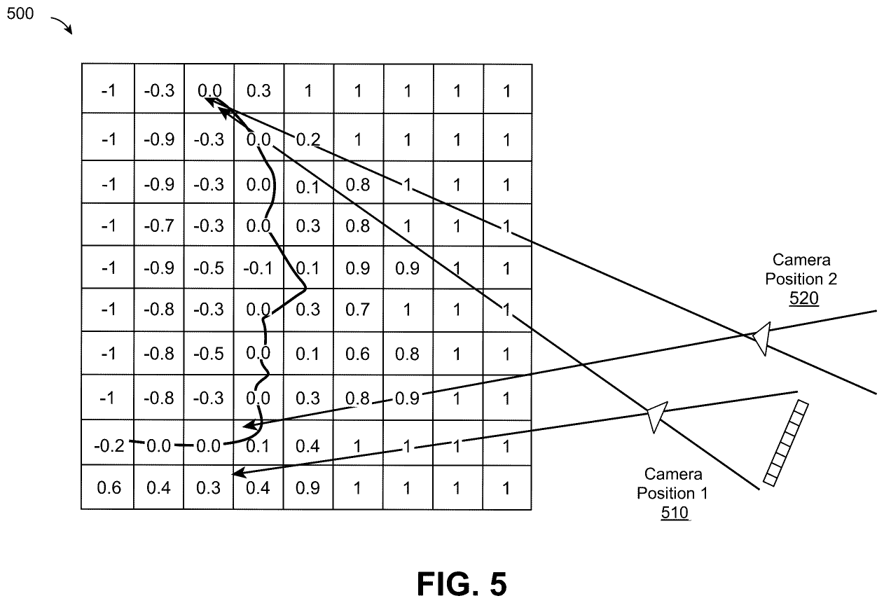

FIG. 5 is a diagram illustrating an example of a TSDF volume reconstruction 500. In FIG. 5, a voxel grid including a plurality of voxel blocks is shown. A camera is shown to be obtaining images of a scene (e.g., person's face) from two different camera positions (e.g., camera position 510 and camera position 520). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 5, the voxel blocks with positive values are shown to be located in front of the person's face, the voxel blocks with negative values are shown to be located inside of the person's face, and the voxel blocks with zero values are shown to be located on the surface of the person's face.

As previously mentioned, in 3DR, 3D scenes are represented using a 3D volume of points called voxel blocks. Typically, each voxel block carries implicit surface information (e.g., in the form of a TSDF value and a weight for depth integration). The TSDF value is a measure of distance of the voxel block from a surface. The weight is a measure of the reliability of the TSDF value. In some cases, a TSDF weight may be estimated using various approaches, such as a simple counter (e.g., a binary weight, such as “1” or “0”), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to “1.”

A 3DR system can utilize a sequence of depth maps of a scene with their corresponding 6 DoF poses as an input. The depth maps may be generated using deep learning (DL), non-DL, and/or other depth estimation algorithms or methods. A 3D space of the scene may be uniformly sampled along the X, Y, and Z directions. The 3D space may be divided into fixed size volumes (e.g., block volumes with a fixed number of samples).

A 3DR system generally consists of three stages, which include block selection, integration, and surface extraction. During block selection, all of the blocks that have surfaces or are located close to a surface may be selected. These blocks may then be allocated into memory. In block integration, all voxel blocks within a block volume may be iterated over and an updated TSDF value weight can be calculated. In surface extraction, marching cubes may be used to determine triangular surfaces in the blocks.

In block selection, depth pixels may be iterated over to unproject them to a 3D space and determine where they lie within the 3D space using intrinsic and extrinsic camera parameters. Usually, a hash map is employed for block selection. A hash map is an unordered map, which includes a listing of blocks (e.g., including block indices of the blocks) that have a surface. The hash map may include a corresponding counter for each of the blocks that maintains a count of the number of times depth pixels lie within the particular block. A threshold (e.g., threshold value or number) may be used to select all the blocks that have depth pixels lie within them for more than the threshold number of times. The selected blocks may then be integrated.

FIG. 6 is a diagram of an example voxel block selection algorithm for 3DR of a scene. In particular, FIG. 6 is a diagram illustrating an example of a voxel-block-selection algorithm 600. In FIG. 6, for operation of the voxel-block-selection algorithm 600, a plurality of depth pixels associated with a plurality of depth maps of the scene can be obtained by one or more processors. In one or more examples, each depth map of the plurality of depth maps is associated with a respective pose (e.g., 6 DoF pose) of an image sensor (e.g., a scene-facing camera of an extended reality (XR) device). In some examples, each depth pixel of the plurality of depth pixels is associated with a depth value. The one or more processors can iterate the voxel-block-selection algorithm 600 over every depth value in the depth maps.

During operation of the voxel-block-selection algorithm 600, at operation 610, the one or more processors can convert the depth values of the plurality of depth pixels to a plurality of global three-dimensional (3D) points in a global coordinate system. In one or more examples, the converting of the depth values of the plurality of depth pixels to the plurality of global 3D points in the global coordinate system can be achieved by the one or more processors unprojecting the depth values to a 3D space. At operation 620, the one or more processors can determine indices of blocks (e.g., voxel blocks) associated with the plurality of global 3D points. At operation 630, the one or more processors can generate a listing of blocks including the indices of the blocks associated with the plurality of global 3D points and indices of neighboring blocks adjacent (e.g., next to or close) to the blocks associated with the plurality of global 3D points.

The one or more processors can then select the plurality of blocks of the scene from the listing of blocks based on a number of depth pixels of the plurality of depth pixels being located within the plurality of blocks. For example, at operation 640, the one or more processors can increment a counter for each block in the listing of blocks each time a depth pixel of the plurality of depth pixels is located within each block. The one or more processors can write the indices and the corresponding counter values of the blocks in the listing of the blocks in memory (e.g., a hardware cache).

At operation 650, the one or more processors can determine blocks in the listing of blocks with a counter value greater than a threshold value (e.g., a threshold number). The one or more processors can then select the plurality of blocks of the scene based on the blocks in the listing of blocks with the counter value greater than the threshold value. The one or more processors can write the indices of the selected plurality of blocks of the scene in memory (e.g., the hardware cache).

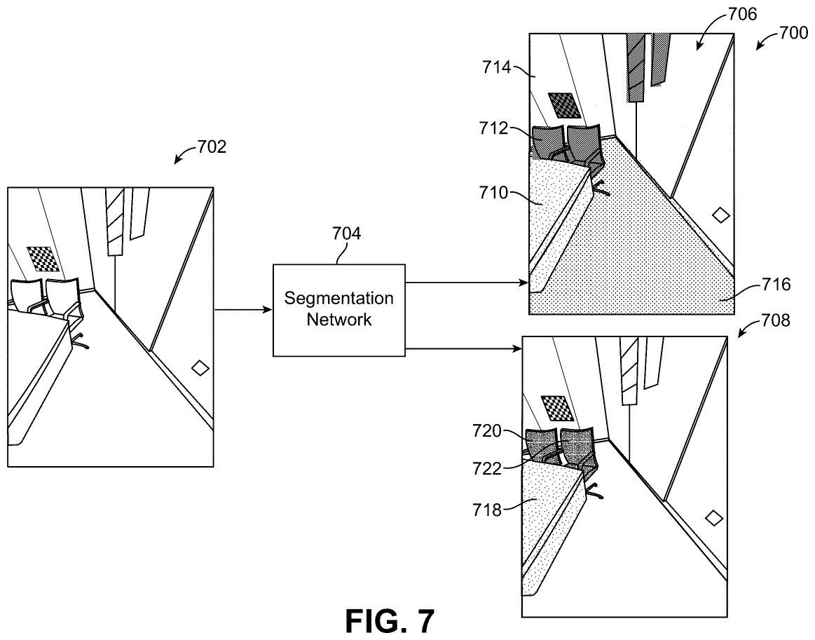

FIG. 7 is a diagram illustrating an example system 700 for generating segmentation and/or instance data, according to various aspects of the present disclosure. For example, a segmentation network 704 may generate semantic map 706 and/or instance map 708 based on image data 702.

Image data 702 may be an image of a scene. The scene may include one or more objects (e.g., chairs, and a table). The scene may include background (e.g., walls and the floor). Image data 702 may be a color image (e.g., including red, green, and blue data for each pixel). Alternatively, image data 702 may be a black and white image (e.g., including intensity data from each pixel).

Segmentation network 704 may be a machine-learning model trained to segment images. Additionally or alternatively, segmentation network 704 may be trained to generate instance maps. For example, segmentation network 704 may be, or may include, a panoptic segmentation network.

Semantic map 706 may include a semantic label for each pixel of image data 702. Semantic map 706 is presented in FIG. 7 as overlaid onto image data 702 for illustrative purposes. Semantic map 706 may include a mask, for example, including a semantic labels associated with pixels of various regions of image data 702. For example, semantic map 706 may include a semantic label (e.g., “table”) associated with pixels in a first region 710, another semantic label (e.g., “chair”) associated with pixels in a second region 712, another semantic label (e.g., “wall”) associated with pixels in a third region 714, and another semantic label (e.g., “floor”) associated with pixels in a fourth region 716.

Instance map 708 may include pixel identifiers for pixels of the image data that represent objects in the scene. Instance map 708 is presented in FIG. 7 as overlaid onto image data 702 for illustrative purposes. Instance map 708 may include a mask, for example, including a pixel identifiers (e.g., an identifiers (IDs), such as numbers) associated with pixels of image data 702 that represent various objects. For example, instance map 708 may include a map indicating that pixels in region 718 are associated with a first identifier (e.g., 1), that pixels in region 720 are associated with a second identifier (e.g., 2), and that pixels in region 722 are associated with a third identifier (e.g., 3). In some aspects, instance map 708 may include an indication that pixels not associated with an object are background pixels. For example, instance map 708 may include an indication that pixels not in region 718, region 720 or region 722 are associated with a fourth identifier (e.g., 0).

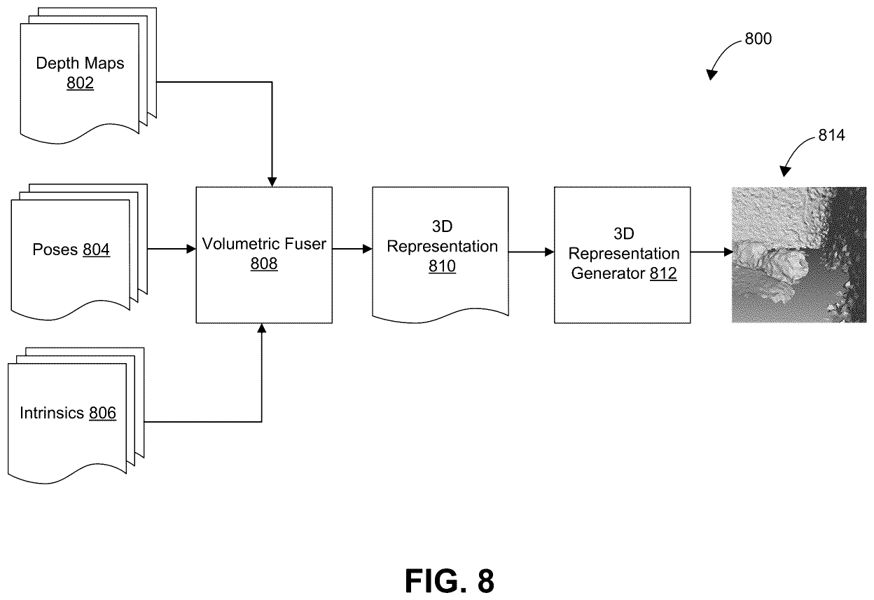

FIG. 8 is a block diagram illustrating an example system 800 for generating a 3D representation 814, according to various aspects of the present disclosure. In general, a volumetric fuser 808 may fuse data of depth maps 802, poses 804, and intrinsics 806 to generate a 3D representation 810 (e.g., a voxel-based representation) of the scene, objects, and/or people represented by depth maps 802. Additionally, 3D representation generator 812 may extract 3D representation 814 (e.g., a 3D mesh) based on 3D representation 810.

Depth maps 802 may include multiple depth maps representing the same scene, objects, and/or people from different perspectives. Depth maps 802 may be generated according to any suitable depth-determination technique, such as, a projection-based depth-estimation technique (e.g., as described with regard to FIG. 1), a depth from stereo (DFS) technique, a patterned-illumination technique, a phase-detection technique, and/or a monocular depth-estimation (e.g., machine-learning-model-based) technique.

Poses 804 may be, or may include, poses (e.g., positions and orientations) from which data on which depth maps 802 are based was captured. For example, poses 804 may include a pose (e.g., position and orientation) from which an infrared (IR) time-of-flight (TOF) depth-determination system projected IR light into a scene and received the reflected IR light to determine a depth map of depth maps 802. Poses 804 may include one pose for each of depth maps 802. Poses 804 may be relative to the scene. For example, poses 804 may be in a coordinate system relative to a scene represented by depth maps 802.

Intrinsics 806 may include intrinsic parameters of a system used to generate depth maps 802. For example, if cameras (e.g., stereoscopically-paired cameras) were used to capture data on which depth maps 802 is based, intrinsics 806 may include intrinsic parameters, such as focal lengths and/or lens information of the cameras.

Volumetric fuser 808 may project depth data from depth maps 802 into a common 3D representation of the scene (e.g., 3D representation 810). Volumetric fuser 808 may construct a grid of voxels and compute for each voxel, the distance to the closest 3D point. Volumetric fuser 808 may build a TSDF scene representation (e.g., as described with regard to FIG. 2 through FIG. 6.

3D representation generator 812 may use a marching-cube, or similar algorithm, to extract a 3D mesh following the surfaces of objects in the scene.

The goal of this work is to assign to each voxel in 3D (or a vertex on the mesh) an object instance ID, such that voxels/vertices belonging to the same object have the same ID.

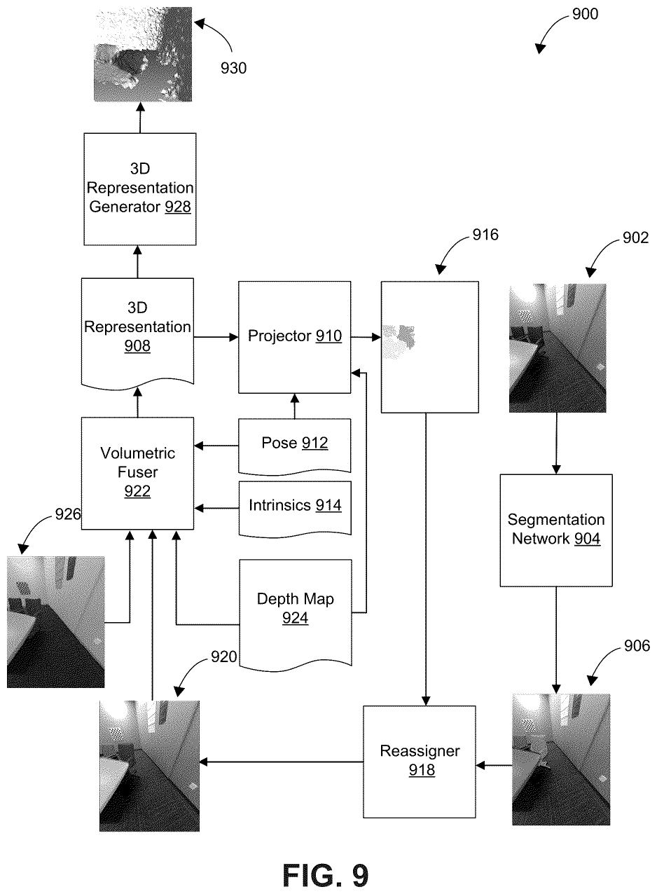

FIG. 9 is a block diagram illustrating a system 900 for generating a 3D representation 908, according to various aspects of the present disclosure. System 900 may iteratively generate 3D representation 908 based on a number of images and depth maps of a scene. One step of the iterative process of generating 3D representation 908 is described with regard to FIG. 9. The step may be repeated any number of times based on any number of additional instances of image data 902 and depth map 924.

For example, segmentation network 904 may process image data 902 to generate instance map 906. Instance map 906 may include pixel identifiers. Projector 910 may project 3D-point identifiers of 3D representation 908 to generate projected instance map 916. Projected instance map 916 may include projected identifiers. Reassigner 918 may generate reassigned instance map 920 by reassigning pixel identifiers of instance map 906 based on projected identifiers of projected instance map 916. Volumetric fuser 922 may modify 3D representation 908 based on depth map 924 (which may relate to image data 902). Additionally, volumetric fuser 922 may modify at least one 3D-point identifier of 3D representation 908 based on reassigned identifiers of reassigned instance map 920. For example, volumetric fuser 922 may add at least one 3D-point identifier of the reassigned identifiers of reassigned instance map 920 to 3D representation 908. As another example, volumetric fuser 922 may modify at least one 3D-point identifier of 3D representation 908 such that the modified 3D-point identifier matches a reassigned identifiers of reassigned instance map 920.

Image data 902 may be, or may include, an image of a scene. Image data 902 may the same as, or may be substantially similar to, image data 702 of FIG. 7.

Segmentation network 904 may generate instance map 906 based on image data 902. Additionally, in some aspects, segmentation network 904 may generate semantic mask 926 based on image data 902. Segmentation network 904 may be the same as, may be substantially similar to, and/or may perform the same, or substantially the same, operations as segmentation network 704 of FIG. 7.

Instance map 906 may include pixel identifiers for pixels of the image data that represent objects in the scene. Instance map 906 is presented in FIG. 9 as overlaid onto image data 902 for illustrative purposes. Instance map 906 may include a mask, for example, including a pixel identifiers (e.g., an identifiers (IDs), such as numbers) associated with pixels of image data 902 that represent various objects. Instance map 906 may be the same as, or may be substantially similar to, instance map 708 of FIG. 7.

3D representation 908 may be a 3D representation of the scene represented by image data 902 and depth map 924. System 900 may iteratively generate 3D representation 908.

3D representation 908 may be the same as, or may be substantially similar to, 3D representation 810 of FIG. 8. Additionally, 3D representation 908 may include 3D-point identifiers. The 3D-point identifiers of 3D representation 908 may indicate objects associated with various 3D points of 3D representation 908. For example, 3D representation 908 may be, or may include, a voxel-based representation of the scene. Some, or all, of the voxels of 3D representation 908 may be associated with a 3D-point identifier. The 3D-point identifier of a given voxel may be indicative of an object of which the given voxel represents a point. As an analogy, as a pixel identifier of instance map 906 indicates an identifier for an object represented by a pixel of image data 902 that corresponds to the pixel identifier, a 3D-point identifier of 3D representation 908 indicates an identifier for an object represented by a 3D point of 3D representation 908 that corresponding to the 3D-point identifier.

Pose 912 may be a pose (position and orientation) from which image data 902 was captured. Pose 912 may be the same as, or may be substantially similar to, one of poses 804 of FIG. 8. Intrinsics 914 may be, or may include, intrinsic parameters of a camera which captured image data 902 and/or a depth-estimation system which generated depth map 924.

Projector 910 may project 3D-point identifiers of 3D representation 908 to an image plane that is based on pose 912 and intrinsics 914 to generate projected instance map 916. For example, projector 910 may project rays from a number of 3D-point identifiers of 3D representation 908 through a camera center from which image data 902 was captured to an image plane. Where a ray from a 3D-point identifier intersects the image plane, projector 910 may store a projected identifier of projected instance map 916.

In some aspects, projector 910 may project all 3D-point identifiers of 3D representation 908 that would be visible from pose 912. In other aspects, projector 910 may project a subset of 3D-point identifiers that would be visible from pose 912. For example, in some aspects, projector 910 may project 3D-point identifiers based on pixel identifiers of instance map 906. For example, projector 910 may obtain instance map 906 (or a mask related to instance map 906). Projector 910 may determine, based on instance map 906, which 3D-point identifiers of 3D representation 908 may be subject to the reassignment later (e.g., based on the 3D-point identifiers being projected onto an image plane corresponding to instance map 906). Projector 910 may project the 3D-point identifiers that may be subject to reassignment and may determine to not project 3D-point identifiers that may not be subject to reassignment.

Additionally or alternatively, projector 910 may subsample (e.g., randomly) 3D-point identifiers before projecting the 3D-point identifiers. For example, to reduce the number of rays to cast onto the image plane, projector 910 may subsample 3D-point identifiers (e.g., randomly) and project rays from the subsampled set of 3D-point identifiers. In some aspects, projector 910 may subsample 3D-point identifiers based on an object mask (e.g., instance map 906). It is possible to subsample the 3D-point identifiers because reassigner 918 may reassign all identifiers related to a given object to be related to a different object and reassigner 918 may determine whether to reassign all the identifiers related to the given object based on a subset of the identifiers.

In any case, projector 910 may generate projected instance map 916. Projected instance map 916 may be a mask including projected identifiers. Projected identifiers may indicate positions where 3D-point identifiers would appear in an image plane corresponding to image data 902.

Reassigner 918 may reassign pixel identifiers of instance map 906 to correspond to projected identifiers of projected instance map 916. For example, a 3D representation of a table in a scene may have an ID of 1 in 3D representation 908 (which is a 3D representation of the scene). Additionally, a first chair in the scene may have an ID of 2 in 3D representation 908, and a third chair in the scene may have an ID of 3 in 3D representation 908. Projected instance map 916 may include a projection of the table, the first chair, and the second chair into an image plane corresponding to image data 902. A region of projected instance map 916 corresponding to where the 3D representation of the table would be visible in the image plane corresponding to image data 902 may have an ID of 1. Similarly, a region of projected instance map 916 corresponding to where the 3D representation of the first chair would be visible in the image plane corresponding to image data 902 may have an ID of 2. Further, a region of projected instance map 916 corresponding to where the 3D representation of the second chair would be visible in the image plane corresponding to image data 902 may have an ID of 3.

Continuing the example, segmentation network 904 may arbitrarily assign IDs to objects in image data 902. There may be no correlation between IDs in a first instance of image data 902 and a second instance of image data 902 (even if the two instances of image data 902 are substantially the same). In instance map 906, pixels representing the table in the scene may have an ID of 2, pixels representing the first chair may have an ID of 1, and pixels representing the second chair may have an ID of 3.

Continuing the example, reassigner 918 may reassign pixel identifiers of instance map 906 to correspond to projected identifiers of projected instance map 916. For example, reassigner 918 may generate reassigned instance map 920 including reassigned identifiers, such that the reassigned identifiers correspond to projected instance map 916. For instance, reassigner 918 may reassign the ID of the pixel identifiers related to the table from the ID of 2 (as in instance map 906) to the ID of 1 (as in projected instance map 916). Similarly, reassigner 918 may reassign the ID of the pixel identifiers related to the first chair from the ID of 1 (as in instance map 906) to the ID of 2 (as in projected instance map 916). Reassigned instance map 920 is presented in FIG. 9 as overlaid onto image data 902 for illustrative purposes.

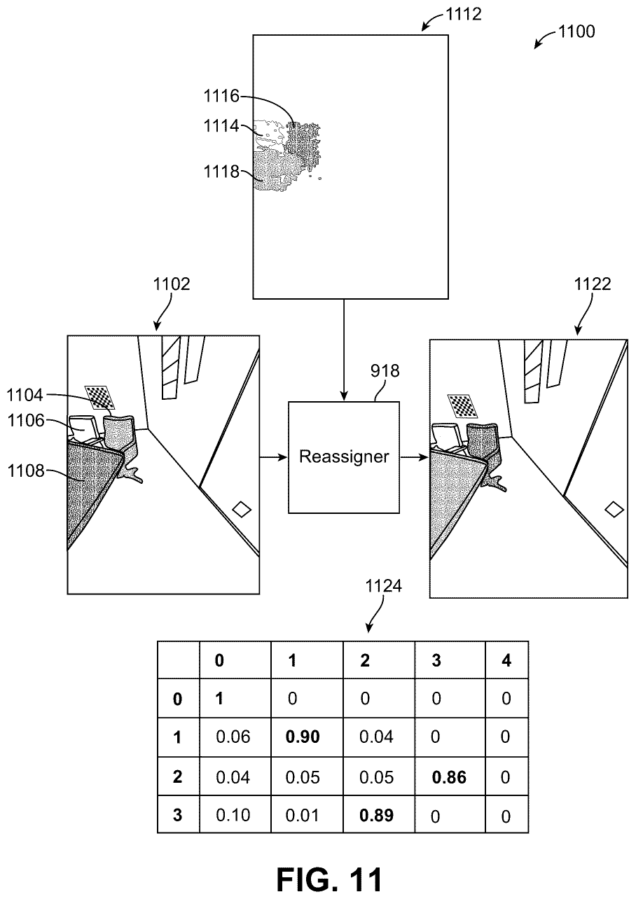

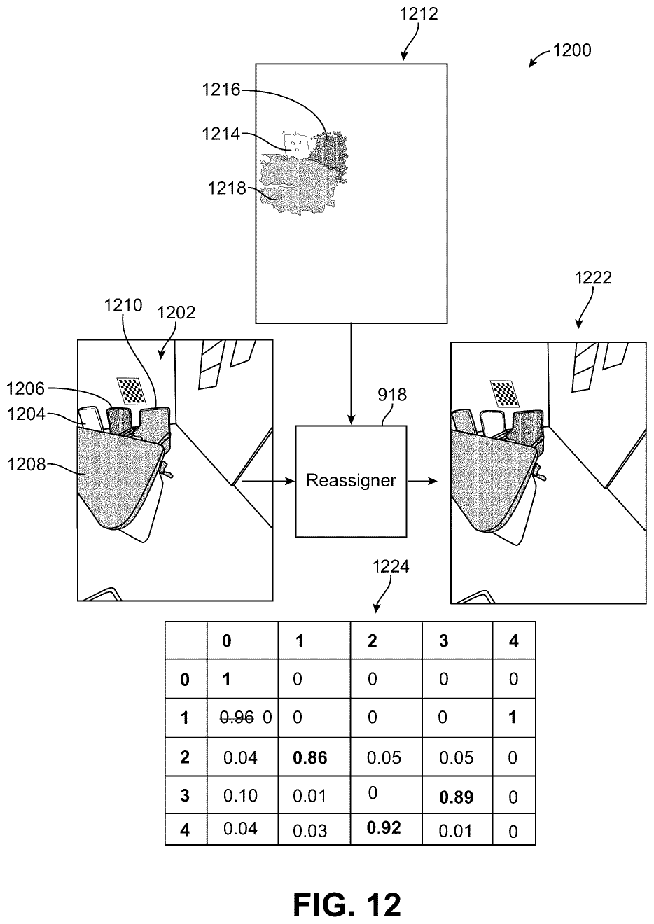

To correlate the projected identifiers of projected instance map 916 to the pixel identifiers of instance map 906, reassigner 918 may use a linear-optimization algorithm (e.g., a Hungarian matching algorithm). Examples of reassigning IDs is given with regard to FIG. 11 and FIG. 12.

Depth map 924 may be, or may include, a number of depth values representing depths to points in the scene. Depth map 924 may represent depths from pose 912, for example, the data on which depth map 924 is based (e.g., TOF data, stereoscopic image data, etc.) may have been captured from pose 912. The data on which depth map 924 is based may have been captured at substantially the same time image data 902 is captured. image data 902 and depth map 924 may be related based on image data 902 and depth map 924 having been captured from pose 912. As such image data 902 and depth map 924 may both represent the same scene. Depth map 924 may be the same as, or may be substantially similar to, one of depth maps 802 of FIG. 8.

Volumetric fuser 922 may iteratively generate (e.g., update) 3D representation 908 based on depth map 924, pose 912, and intrinsics 914. For example, volumetric fuser 922 may add and/or adjust 3D points of 3D representation 908 based on depth map 924. For instance, depth map 924 may represent distances from pose 912 to points in a scene. 3D representation 908 may represent the scene. Volumetric fuser 922 may add 3D points to 3D representation 908 (or adjust the position of 3D points of 3D representation 908) based on distances in depth map 924 as observed from pose 912 in the scene.

Additionally, volumetric fuser 922 may add or modify 3D-point identifiers of 3D representation 908 based on reassigned identifiers of reassigned instance map 920. For example, reassigned instance map 920 may include 3D-point identifiers. As volumetric fuser 922 adds 3D points to 3D representation 908 based on depth map 924, volumetric fuser 922 may add identifiers (e.g., 3D-point identifiers) to the added 3D points based on the reassigned identifiers of reassigned instance map 920. As another example, as volumetric fuser 922 modifies 3D points of 3D representation 908 (e.g., modifies the 3D position of points, such as, based on a new view of the 3D points of depth map 924 from pose 912), volumetric fuser 922 may modify 3D-point identifiers of 3D representation 908. As another example, volumetric fuser 922 may modify 3D-point identifiers of 3D representation 908 based on reassigned identifiers of reassigned instance map 920, for example, to change a 3D-point identifier of a 3D point from being associated with one object to being associated with another object (e.g., based on viewing the objects from a new pose, such as pose 912).

The fusion of identifiers in the 3D representation 908 (e.g., a voxel grid volume) may be performed by overwriting an instance attribute of every voxel onto which the 2D reassigned label (e.g., reassigned identifiers of reassigned instance map 920) is projected based on the depth map 924, pose 912, and intrinsics 914. To reduce noise from inaccurate object masks or depth readings, every voxel may include a semantic attribute called “objectness,” which may represent the probability that the voxel belongs to an object (e.g., as compared to the background). Thus, background voxels, which might have been mistakenly assigned object IDs, have a chance to be corrected (unassigned), if their objectness score drops below a certain threshold. This may happen multiple times as the process of generating 3D representation 908 is incremental, and over time, multiple views of the scene are fused, reducing the noise.

To model the objectness score of a voxel, volumetric fuser 922 may use semantic mask 926 (e.g., generated by segmentation network 904 based on image data 902). Semantic mask 926 may correspond to image data 902 and group all objects of interest into one “object” class and the rest as “background.” Semantic mask 926 is presented in FIG. 9 as overlaid onto image data 902 for illustrative purposes. In this example, segmentation network 904 may model “Chair” and “Table” classes as objects. The fusion of the semantic attribute in every voxel s_{VG} may be performed according to a weighted TSDF fusion: s_{VG}:=(s_{VG}*w+sᵢₙₚᵤₜ)/(w+1) and weight update w:=w+1.

In some aspects, 3D representation generator 928 may generate 3D representation 930 based on 3D representation 908. 3D representation generator 928 may be the same as, may be substantially similar to, and/or may perform the same, or substantially the same, operations as 3D representation generator 812 of FIG. 8. Similarly, 3D representation 930 may be the same as, or may be substantially similar to, 3D representation 814. Additionally, 3D representation generator 928 may cause 3D representation 930 to include identifiers. For example, points (e.g., vertices) of 3D representation 930 may include identifiers (e.g., IDs).

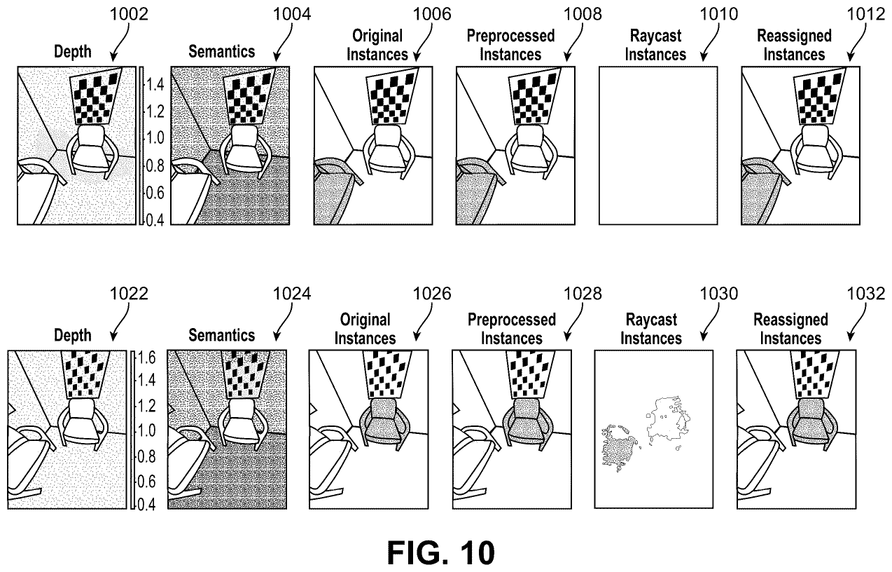

FIG. 10 includes a number of visual representations of various data used in generating a 3D representation, according to various aspects of the present disclosure. For example, FIG. 10 includes visual representations of data used in a first step of generating a 3D representation of a scene and visual representations of data used in a second step of generating a 3D representation of the scene, according to various aspects of the present disclosure.

Depth map 1002 and depth map 1022 are respective visual representations of depth maps overlaid with black and white image data for illustrative purposes. The colors of depth map 1002 and depth map 1022 indicate depths. The depth values of depth map 1002 and the depth values of depth map 1022 are examples two instances of depth map 924 of FIG. 9 (e.g., generated for separate steps of the process of generating 3D representation 908).

Semantic mask 1004 and semantic mask 1024 are respective visual representations of semantic masks overlaid with black and which image data for illustrative purposes. The colors of semantic mask 1004 and semantic mask 1024 may indicate various semantic labels of groups of pixels. Semantic mask 1004 and semantic mask 1024 are examples of two instances of semantic mask 926 of FIG. 9 (e.g., generated for separate steps of the process of generating 3D representation 908).

Instance map 1006 and instance map 1026 are respective visual representations of instance maps overlaid with a black and white image data for illustrative purposes. The colors of instance map 1006 and instance map 1026 may indicate various pixel identifiers. Instance map 1006 and instance map 1026 are examples of two instances of instance map 906 of FIG. 9 (e.g., generated for separate steps of the process of generating 3D representation 908).

Instance map 1008 and instance map 1028 are respective visual representations of processed instance maps overlaid with a black and white image data for illustrative purposes. The colors of instance map 1008 and instance map 1028 may indicate various pixel identifiers. Instance map 1008 may be a processed instance of instance map 1006. Instance map 1028 may be a processed instance of instance map 1026. For example, instance map 1006 and instance map 1026 may be filtered by one or more filters that may make the generation of 3D representation 908 more robust in the presence of misalignment and noise in the depth source, wrong predictions from the semantic and instance segmentation network etc. For example, one such filter is on the detected object size. If an object is too small (e.g., smaller than a threshold size), based on the area of the instance mask, then it may be assumed that the object is too far away. It may be better to not integrate objects that are too far away into 3D representation 908. Accordingly, system 900 may wait for additional depth maps in which the depth sensor is closer to the object. Another example preprocessing step is concerned with the coverage of the detected object by depth values. Due to the sparsity of some depth maps, it can be that a sizeable objects are not reconstructed and hence no need to include those instances in the reassignment optimization step. System 900 may include a preprocessor (not illustrated in FIG. 9). Instance map 1008 and instance map 1028 are examples of two instances of an output of such a preprocessor (e.g., based on two respective instances of instance map 906). Instance map 1008 and instance map 1028 may be generated in separate steps of the process of generating 3D representation 908.

Projected instance map 1010 and projected instance map 1030 are respective visual representations of projected instance maps. The colors of projected instance map 1010 and projected instance map 1030 indicate various projected identifiers. Projected instance map 1010 and projected instance map 1030 are examples of respective instances of projected instance map 916 of FIG. 9 (e.g., generated in separate steps of the process of generating 3D representation 908).

Reassigned instance map 1012 and reassigned instance map 1032 are respective visual representations of reassigned instance maps overlaid with black and white image data. The colors of reassigned instance map 1012 and reassigned instance map 1032 indicate various reassigned identifiers. Reassigned instance map 1012 and reassigned instance map 1032 are examples of two instances of reassigned instance map 920 of FIG. 9 (e.g., generated in separate steps of the process of generating 3D representation 908).

Projected instance map 1010 does not include color because, in the example of FIG. 10, projected instance map 1010 is a first projected instance map, generated before 3D representation 908 has been generated based on identifiers. In the first of the process of generating 3D representation 908, reassigned instance map 1012 may be processed by volumetric fuser 922 such that 3D representation 908 includes identifier data based on reassigned instance map 1012. In the second instance of the process of generating 3D representation 908, the identifier data in 3D representation 908 may be projected to generate projected instance map 1030.

The identifiers of instance map 1008 do not match the identifiers of instance map 1028. A segmentation network (e.g., segmentation network 704) that generated instance map 1006 and instance map 1026 may generate identifiers arbitrarily. As such, there may, or may not, be a correspondence between identifiers of instance map 1006 and instance map 1026.

Reassigner 918 may reassign identifiers of instance map 1028, based on projected instance map 1030, to generate reassigned instance map 1032 such that the identifiers of reassigned instance map 1032 match the identifiers of 3D representation 908. In other words, reassigner 918 may cause identifiers of objects in the scene to be consisted across instances of reassigned instance maps such that as system 900 generates 3D representation 908, 3D representation 908 may include objects with identifiers.

FIG. 11 is a diagram illustrating an example scenario 1100 to illustrate operations of reassigner 918 of FIG. 9, according to various aspects of the present disclosure. In general, reassigner 918 may reassign pixel identifiers of instance map 1102 to correspond to projected identifiers of projected instance map 1112. Reassigner 918 may generate reassigned instance map 1122 including reassigned identifiers, including the reassigned pixel identifiers of instance map 1102.

Instance map 1102 is an example of instance map 906 of FIG. 9. Instance map 1102 is presented in FIG. 11 as overlaid onto image data for illustrative purposes. In practice, instance map 1102 may be a mask (e.g., without color and/or intensity values). The color and/or intensity values of the mask serve to illustrate regions of the mask. Projected instance map 1112 is an example of projected instance map 916 of FIG. 9. Reassigned instance map 1122 is an example of reassigned instance map 920 of FIG. 9. Reassigned instance map 1122 is presented in FIG. 11 as overlaid onto image data for illustrative purposes. In practice, reassigned instance map 1122 may be a mask.

Reassigner 918 may match the projected identifiers of projected instance map 1112 to pixel identifiers of instance map 1102 based on the area of projection into every object mask. As an example, reassigner 918 may implement a Hungarian Matching algorithm (which may also be referred to as a linear-sum-assignment solver).

For example, to determine the matches, reassigner 918 may create a utility matrix 1124. In utility matrix 1124, every row may correspond to a pixel identifier in instance map 1102. For example, row 1 of utility matrix 1124 may correspond to a region 1106 of instance map 1102. Region 1106 may have an ID of 1 in instance map 1102. Row 2 of utility matrix 1124 may correspond to a region 1104 of instance map 1102. Region 1104 may have an ID of 2 in instance map 1102. Row 3 of utility matrix 1124 may correspond to a region 1108 of instance map 1102. Region 1108 may have an ID of 3 in instance map 1102.

In utility matrix 1124, every column may correspond to a projected identifier of a globally tracked set of object IDs. The objects observed in projected instance map 1112 may represent a subset of the globally tracked set of object IDs (e.g., a subset of the globally tracked set of object IDs that are visible from pose 912).

For example, column 1 of utility matrix 1124 may correspond to a region 1114 of projected instance map 1112. Region 1114 may have an ID of 1 in projected instance map 1112. Column 2 of utility matrix 1124 may correspond to a region 1118 of projected instance map 1112. Region 1118 may have an ID of 2 in projected instance map 1112. Column 3 of utility matrix 1124 may correspond to a region 1116 of projected instance map 1112. Region 1116 may have an ID of 3 in projected instance map 1112.

The values in utility matrix 1124 may be determined based on a correspondence between regions of projected instance map 1112 and regions of instance map 1102. For example, every value in utility matrix 1124 may be determined by the overlap of the normalized area of the regions of projected instance map 1112 with the regions of instance map 1102. For example, a value in row 1, column 1 of utility matrix 1124 may be based on a normalize percentage of overlap between region 1114 and region 1106. A value in row 2, column 1, of utility matrix 1124 may be based on a normalize percentage of overlap between region 1114 and region 1104. A value in row 3, column 1, of utility matrix 1124 may be based on a normalize percentage of overlap between region 1114 and region 1108.

Reassigner 918 may select a value of one columns for every row such that the sum of all values is maximized. For example, reassigner 918 may perform a Hungarian Matching on utility matrix 1124.

To ensure that the background is not matched to any object, reassigner 918 may assign a high value (e.g., 1) in the (0, 0) entry and 0s in every other column of the 0th row.

One or more columns may be reserved for newly-observed objects. For example, Column 4 may be included in utility matrix 1124 objects that may be observed in further image images of the scene. If additional objects are not detected in images of a scene, the reserved columns may remain empty. If the number of detected objects exceeds the number of columns, a bigger matrix may be reinitialized.

According to the example illustrated in FIG. 11, reassigner 918 may reassign a pixel identifier of region 1104 from 2 to 3 and a pixel identifier of region 1108 from 3 to 2 based on region 1108 relating to region 1118 (which has an ID of 2) and region 1104 relating to region 1116 (which has an ID of 3). In this example, the relation refers to the percentage of overlap of region 1118 with region 1108 and the percentage of overlap of region 1116 with region 1104.

FIG. 12 is a diagram illustrating another example scenario 1200 to illustrate operations of reassigner 918 of FIG. 9, according to various aspects of the present disclosure. In general, reassigner 918 may reassign pixel identifiers of instance map 1202 to correspond to projected identifiers of projected instance map 1212. Reassigner 918 may generate reassigned instance map 1222 including reassigned identifiers, including the reassigned pixel identifiers of instance map 1202.

Instance map 1202 is an example of instance map 906 of FIG. 9. Instance map 1202 is presented in FIG. 12 as overlaid onto image data for illustrative purposes. Instance map 1202 includes region 1204, region 1206, region 1208 and region 1210 as examples. In practice, instance map 1202 may be a mask (e.g., without intensity color or values). The color and/or intensity values of the mask serve to illustrate regions of the mask.

Projected instance map 1212 is an example of projected instance map 916 of FIG. 9. Projected instance map 1212 includes region 1214, region 1216, and region 1218 as examples.

Reassigned instance map 1222 is an example of reassigned instance map 920 of FIG. 9. Reassigned instance map 1222 is presented in FIG. 12 as overlaid onto image data for illustrative purposes. In practice, reassigned instance map 1222 may be a mask.

Reassigner 918 may perform the same operations in scenario 1200 as in scenario 1100. For example, reassigner 918 may match regions of projected instance map 1212 with regions of instance map 1202 based on overlap. Further, reassigner 918 may reassign pixel identifiers of instance map 1202 based on the matching to generate reassigned instance map 1222.

However, instance map 1202 includes a new pixel identifier for a new object (e.g., region 1204) The new object may not have been visible in any prior image of the scene. Therefore 3D representation 908 may not yet represent the new object (because no depth map has included the object). Because 3D representation 908 does not include the new object, projected instance map 1212 does not include a region corresponding to the new object.

The newly-detected object (e.g., which hasn't been observed before in image data 902 and depth map 924) may be assigned to background. To avoid this, reassigner 918 may assign a large value in a new column (e.g., column 4 of utility matrix 1224 which corresponds to a new object in a globally tracked set of object IDs). To avoid assignment based on a small set of projected IDs, reassigner 918 may apply a threshold for the area of an object mask that needs to be exceeded to consider an object as already observed.

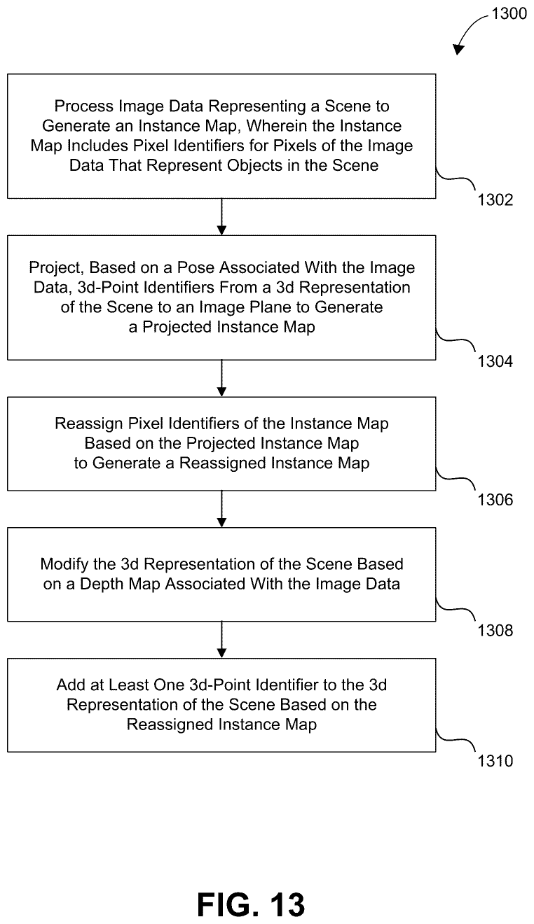

FIG. 13 is a flow diagram illustrating an example process 1300 for generating a 3D representation, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1300. The one or more operations of process 1300 may be implemented as software components that are executed and run on one or more processors.

At block 1302, a computing device (or one or more components thereof) may process image data representing a scene to generate an instance map, wherein the instance map includes pixel identifiers for pixels of the image data that represent objects in the scene. For example, segmentation network 904 may process image data 902 to generate instance map 906. Instance map 906 may include pixel identifiers for pixels of image data 902. The pixel identifiers of instance map 906 may identify objects represented by groups of pixels.

At block 1304, the computing device (or one or more components thereof) may project, based on a pose associated with the image data, 3D-point identifiers from a 3D representation of the scene to an image plane to generate a projected instance map. For example, projector 910 may project 3D-point identifiers from 3D points of 3D representation 908 to an image plane. The image plane may be based on a position from which image data 902 was captured. Where projected 3D-point identifiers intersect with the image plane, projector 910 may store projected identifiers to generate projected instance map 916.

At block 1306, the computing device (or one or more components thereof) may reassign pixel identifiers of the instance map based on the projected instance map to generate a reassigned instance map. For example, reassigner 918 may reassign pixel identifiers of instance map 906 based on projected identifiers of projected instance map 916 to generate reassigned instance map 920 (e.g., as described with regard to FIG. 11 and FIG. 12).

In some aspects, the projected instance map comprises projected identifiers; and the pixel identifiers of the instance map are reassigned to relate to the projected identifiers. For example, projected instance map 916 may include projected identifiers. Reassigner 918 may reassign pixels identifiers of instance map 906 based on projected identifiers of projected instance map 916.

In some aspects, the pixel identifiers of the instance map are reassigned to relate to the projected identifiers according to a linear-optimization algorithm. For example, reassigner 918 may determine relationships between the projected identifiers of projected instance map 916 and the pixel identifiers of instance map 906 according to a linear-optimization algorithm.

In some aspects, the pixel identifiers of the instance map are reassigned to relate to the projected identifiers according to a Hungarian matching algorithm. For example, reassigner 918 may determine relationships between the projected identifiers of projected instance map 916 and the pixel identifiers of instance map 906 according to a Hungarian matching algorithm.

In some aspects, projected identifiers that are related to a background of the scene are assigned a background identifier. For example, projected identifiers that are related to the background of the scene may be assigned to a background identifier. For example, as described with regard to FIG. 11, there may be a background identifier and 3D points and/or pixels may be assigned the background identifier.

In some aspects, the computing device (or one or more components thereof) may determine an identifier mask based on the pixel identifiers of the instance map; wherein the 3D-point identifiers are projected based on the identifier mask. For example, projector 910 may obtain an identifier mask (e.g., identifying pixels of image data 902 that relate to identified objects). Projector 910 may project a subset of the 3D-point identifiers of 3D representation 908 based on the mask (e.g., projecting 3D-point identifiers based on the identifier mask).

In some aspects, a subset of the 3D-point identifiers are projected based on a subsampling of the 3D-point identifiers. For example, projector 910 may project a subset of the 3D-point identifiers of 3D representation 908. For instance, projector 910 may randomly subsample the 3D-point identifiers of 3D representation 908.

At block 1308, the computing device (or one or more components thereof) may modify the 3D representation of the scene based on a depth map associated with the image data. For example, volumetric fuser 922 may modify 3D representation 908 based on depth map 924. Depth map 924 may be a depth map of the scene represented by image data 902 captured from substantially the same position from which image data 902 was captured.

In some aspects, the computing device (or one or more components thereof) may process the image data to generate a semantic map, wherein the semantic map includes a semantic label for each pixel of the image data; and modify at least one 3D label of the 3D representation of the scene based on the semantic map. For example, segmentation network 904 may generate semantic mask 926 based on image data 902. Volumetric fuser 922 may modify 3D representation 908 based on semantic mask 926. For example, volumetric fuser 922 may cause 3D representation 908 to include semantic labels (e.g., for each 3D point of 3D representation 908).

In some aspects, the image data is processed to generate the instance map and the semantic map using a segmentation network trained to segment images and assign instance identifiers. For example, segmentation network 904 may be trained to segment images and assign instance identifiers.

In some aspects, the image data is processed to generate the instance map using a segmentation network trained to assign instance identifiers. For example, segmentation network 904 may be trained to assign instance identifiers.

At block 1310, the computing device (or one or more components thereof) may modify at least one 3D-point identifier to the 3D representation of the scene based on the reassigned instance map. For example, volumetric fuser 922 may modify at least one 3D-point identifier of 3D representation 908 based on reassigned identifiers of reassigned instance map 920. For instance, volumetric fuser 922 may add new 3D-point identifiers to 3D representation 908 based on reassigned identifiers of reassigned instance map 920 including new identifiers. Additionally or alternatively, volumetric fuser 922 may modify a 3D-point identifier of 3D representation 908 (e.g., changing an 3D-point identifier) based on a reassigned identifier of reassigned instance map 920.]

In some aspects, the 3D representation is iteratively generated according to a volumetric truncated signed distance function (TSDF) fusion technique. For example, system 900 may iteratively generate 3D representation 908 by iteratively repeating one or more steps of process 1300 a number of times.

In some aspects, the 3D representation of the scene is modified based on the depth map according to the volumetric TSDF fusion technique. For example, at block 1308, volumetric fuser 922 may modify 3D representation 908 according to the volumetric TSDF fusion technique.

In some aspects, the computing device (or one or more components thereof) may generate a 3D mesh based on the 3D representation of the scene, wherein the 3D mesh includes 3D-mesh identifiers based on the 3D-point identifiers. For example, 3D representation generator 928 may generate 3D representation 930 based on 3D representation 908.

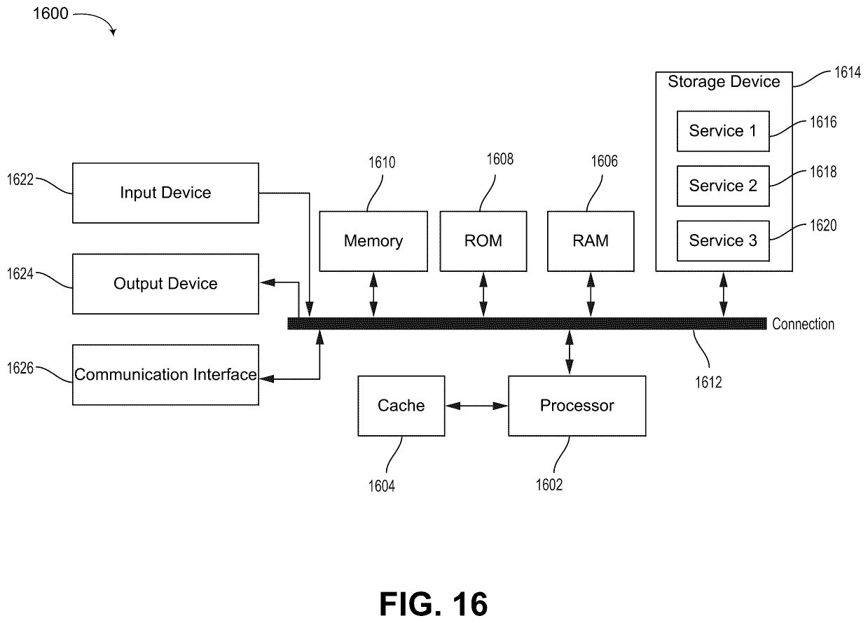

In some examples, as noted previously, the methods described herein (e.g., process 1300 of FIG. 13, and/or other methods described herein) can be performed, in whole or in part, by a computing device or apparatus. In one example, one or more of the methods can be performed by system 900 of FIG. 9, or by another system or device. In another example, one or more of the methods (e.g., process 1300, and/or other methods described herein) can be performed, in whole or in part, by the computing-device architecture 1600 shown in FIG. 16. For instance, a computing device with the computing-device architecture 1600 shown in FIG. 16 can include, or be included in, the components of the system 900 and can implement the operations of process 1300, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1300, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1300, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

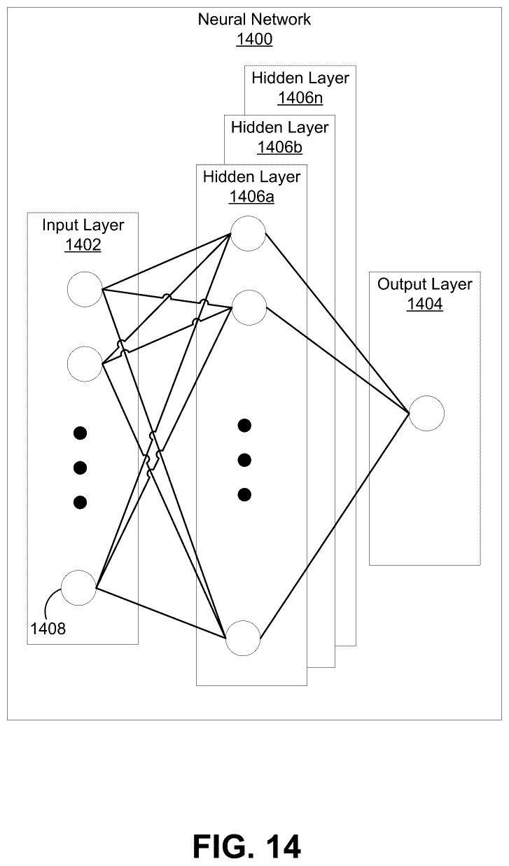

FIG. 14 is an illustrative example of a neural network 1400 (e.g., a deep-learning neural network) that can be used to implement machine-learning-based image segmentation, instance identification, object identification, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1400 may be an example of, or can implement, segmentation network 704 of FIG. 7.

An input layer 1402 includes input data. In one illustrative example, input layer 1402 can include data representing image data 702 and/or image data 902. Neural network 1400 includes multiple hidden layers, for example, hidden layers 1406a, 1406b, through 1406n. The hidden layers 1406a, 1406b, through hidden layer 1406n include “n” number of hidden layers, where “n” is an integer greater than or equal to one. The number of hidden layers can be made to include as many layers as needed for the given application. Neural network 1400 further includes an output layer 1404 that provides an output resulting from the processing performed by the hidden layers 1406a, 1406b, through 1406n. In one illustrative example, output layer 1404 can provide semantic map 706 and/or instance map 708 and/or instance map 906 and/or semantic mask 926.

Neural network 1400 may be, or may include, a multi-layer neural network of interconnected nodes. Each node can represent a piece of information. Information associated with the nodes is shared among the different layers and each layer retains information as information is processed. In some cases, neural network 1400 can include a feed-forward network, in which case there are no feedback connections where outputs of the network are fed back into itself. In some cases, neural network 1400 can include a recurrent neural network, which can have loops that allow information to be carried across nodes while reading in input.

Information can be exchanged between nodes through node-to-node interconnections between the various layers. Nodes of input layer 1402 can activate a set of nodes in the first hidden layer 1406a. For example, as shown, each of the input nodes of input layer 1402 is connected to each of the nodes of the first hidden layer 1406a. The nodes of first hidden layer 1406a can transform the information of each input node by applying activation functions to the input node information. The information derived from the transformation can then be passed to and can activate the nodes of the next hidden layer 1406b, which can perform their own designated functions. Example functions include convolutional, up-sampling, data transformation, and/or any other suitable functions. The output of the hidden layer 1406b can then activate nodes of the next hidden layer, and so on. The output of the last hidden layer 1406n can activate one or more nodes of the output layer 1404, at which an output is provided. In some cases, while nodes (e.g., node 1408) in neural network 1400 are shown as having multiple output lines, a node has a single output and all lines shown as being output from a node represent the same output value.

In some cases, each node or interconnection between nodes can have a weight that is a set of parameters derived from the training of neural network 1400. Once neural network 1400 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1400 to be adaptive to inputs and able to learn as more and more data is processed.

Neural network 1400 may be pre-trained to process the features from the data in the input layer 1402 using the different hidden layers 1406a, 1406b, through 1406n in order to provide the output through the output layer 1404. In an example in which neural network 1400 is used to identify features in images, neural network 1400 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1400 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1400 is trained well enough so that the weights of the layers are accurately tuned.

For the example of identifying objects in images, the forward pass can include passing a training image through neural network 1400. The weights are initially randomized before neural network 1400 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1400, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1400 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1400 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1400 can include any other deep network other than a CNN, such as an autoencoder, a deep belief nets (DBNs), a Recurrent Neural Networks (RNNs), among others.

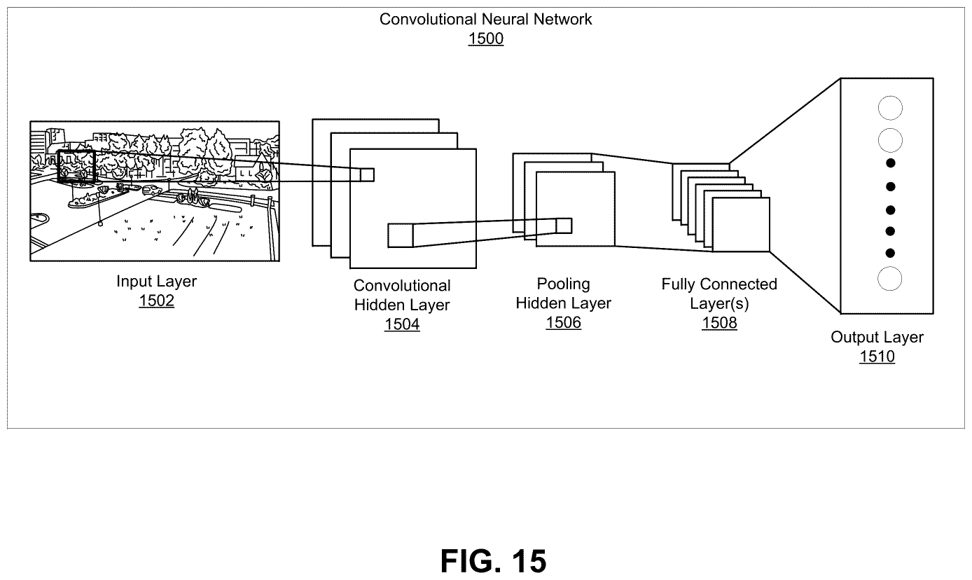

FIG. 15 is an illustrative example of a convolutional neural network (CNN) 1500. The input layer 1502 of the CNN 1500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1504, an optional non-linear activation layer, a pooling hidden layer 1506, and fully connected layer 1508 (which fully connected layer 1508 can be hidden) to get an output at the output layer 1510. While only one of each hidden layer is shown in FIG. 15, one of ordinary skill will appreciate that multiple convolutional hidden layers, non-linear layers, pooling hidden layers, and/or fully connected layers can be included in the CNN 1500. As previously described, the output can indicate a single class of an object or can include a probability of classes that best describe the object in the image.

The first layer of the CNN 1500 can be the convolutional hidden layer 1504. The convolutional hidden layer 1504 can analyze image data of the input layer 1502. Each node of the convolutional hidden layer 1504 is connected to a region of nodes (pixels) of the input image called a receptive field. The convolutional hidden layer 1504 can be considered as one or more filters (each filter corresponding to a different activation or feature map), with each convolutional iteration of a filter being a node or neuron of the convolutional hidden layer 1504. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1504. Each connection between a node and a receptive field for that node learns a weight and, in some cases, an overall bias such that each node learns to analyze its particular local receptive field in the input image. Each node of the convolutional hidden layer 1504 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is5×5×3, corresponding to a size of the receptive field of a node.

The convolutional nature of the convolutional hidden layer 1504 is due to each node of the convolutional layer being applied to its corresponding receptive field. For example, a filter of the convolutional hidden layer 1504 can begin in the top-left corner of the input image array and can convolve around the input image. As noted above, each convolutional iteration of the filter can be considered a node or neuron of the convolutional hidden layer 1504. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1504. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1504.

The mapping from the input layer to the convolutional hidden layer 1504 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1504 can include several activation maps in order to identify multiple features in an image. The example shown in FIG. 15 includes three activation maps. Using three activation maps, the convolutional hidden layer 1504 can detect three different kinds of features, with each feature being detectable across the entire image.

In some examples, a non-linear hidden layer can be applied after the convolutional hidden layer 1504. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1500 without affecting the receptive fields of the convolutional hidden layer 1504.

The pooling hidden layer 1506 can be applied after the convolutional hidden layer 1504 (and after the non-linear hidden layer when used). The pooling hidden layer 1506 is used to simplify the information in the output from the convolutional hidden layer 1504. For example, the pooling hidden layer 1506 can take each activation map output from the convolutional hidden layer 1504 and generates a condensed activation map (or feature map) using a pooling function. Max-pooling is one example of a function performed by a pooling hidden layer. Other forms of pooling functions be used by the pooling hidden layer 1506, such as average pooling, L2-norm pooling, or other suitable pooling functions. A pooling function (e.g., a max-pooling filter, an L2-norm filter, or other suitable pooling filter) is applied to each activation map included in the convolutional hidden layer 1504. In the example shown in FIG. 15, three pooling filters are used for the three activation maps in the convolutional hidden layer 1504.

In some examples, max-pooling can be used by applying a max-pooling filter (e.g., having a size of 2×2) with a stride (e.g., equal to a dimension of the filter, such as a stride of 2) to an activation map output from the convolutional hidden layer 1504. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1504 having a dimension of 24×24 nodes, the output from the pooling hidden layer 1506 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1500.

The final layer of connections in the network is a fully-connected layer that connects every node from the pooling hidden layer 1506 to every one of the output nodes in the output layer 1510. Using the example above, the input layer includes 28×28 nodes encoding the pixel intensities of the input image, the convolutional hidden layer 1504 includes 3×24×24 hidden feature nodes based on application of a 5×5 local receptive field (for the filters) to three activation maps, and the pooling hidden layer 1506 includes a layer of 3×12×12 hidden feature nodes based on application of max-pooling filter to 2×2 regions across each of the three feature maps. Extending this example, the output layer 1510 can include ten output nodes. In such an example, every node of the 3×12×12 pooling hidden layer 1506 is connected to every node of the output layer 1510.

The fully connected layer 1508 can obtain the output of the previous pooling hidden layer 1506 (which should represent the activation maps of high-level features) and determines the features that most correlate to a particular class. For example, the fully connected layer 1508 can determine the high-level features that most strongly correlate to a particular class and can include weights (nodes) for the high-level features. A product can be computed between the weights of the fully connected layer 1508 and the pooling hidden layer 1506 to obtain probabilities for the different classes. For example, if the CNN 1500 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1510 can include an M-dimensional vector (in the prior example, M=10). M indicates the number of classes that the CNN 1500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 16 illustrates an example computing-device architecture 1600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1600 may include, implement, or be included in any or all of system 700 of FIG. 7, system 800 of FIG. 8, system 900 of FIG. 9 and/or other devices, modules, or systems described herein. Additionally or alternatively, computing-device architecture 1600 may be configured to perform process 1300, and/or other process described herein.

The components of computing-device architecture 1600 are shown in electrical communication with each other using connection 1612, such as a bus. The example computing-device architecture 1600 includes a processing unit (CPU or processor) 1602 and computing device connection 1612 that couples various computing device components including computing device memory 1610, such as read only memory (ROM) 1608 and random-access memory (RAM) 1606, to processor 1602.

Computing-device architecture 1600 can include a cache of high-speed memory connected directly with, in close proximity to, or integrated as part of processor 1602. Computing-device architecture 1600 can copy data from memory 1610 and/or the storage device 1614 to cache 1604 for quick access by processor 1602. In this way, the cache can provide a performance boost that avoids processor 1602 delays while waiting for data. These and other modules can control or be configured to control processor 1602 to perform various actions. Other computing device memory 1610 may be available for use as well. Memory 1610 can include multiple different types of memory with different performance characteristics. Processor 1602 can include any general-purpose processor and a hardware or software service, such as service 1 1616, service 2 1618, and service 3 1620 stored in storage device 1614, configured to control processor 1602 as well as a special-purpose processor where software instructions are incorporated into the processor design. Processor 1602 may be a self-contained system, containing multiple cores or processors, a bus, memory controller, cache, etc. A multi-core processor may be symmetric or asymmetric.

To enable user interaction with the computing-device architecture 1600, input device 1622 can represent any number of input mechanisms, such as a microphone for speech, a touch-sensitive screen for gesture or graphical input, keyboard, mouse, motion input, speech and so forth. Output device 1624 can also be one or more of a number of output mechanisms known to those of skill in the art, such as a display, projector, television, speaker device, etc. In some instances, multimodal computing devices can enable a user to provide multiple types of input to communicate with computing-device architecture 1600. Communication interface 1626 can generally govern and manage the user input and computing device output. There is no restriction on operating on any particular hardware arrangement and therefore the basic features here may easily be substituted for improved hardware or firmware arrangements as they are developed.

Storage device 1614 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1606, read only memory (ROM) 1608, and hybrids thereof. Storage device 1614 can include services 1616, 1618, and 1620 for controlling processor 1602. Other hardware or software modules are contemplated. Storage device 1614 can be connected to the computing device connection 1612. In one aspect, a hardware module that performs a particular function can include the software component stored in a computer-readable medium in connection with the necessary hardware components, such as processor 1602, connection 1612, output device 1624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for generating a three-dimensional (3D) scene representation, the apparatus comprising: at least one memory; and at least one processor coupled to the at least one memory and configured to: process image data representing a scene to generate an instance map, wherein the instance map includes pixel identifiers for pixels of the image data that represent objects in the scene; project, based on a pose associated with the image data, 3D-point identifiers from a 3D representation of the scene to an image plane to generate a projected instance map; reassign pixel identifiers of the instance map based on the projected instance map to generate a reassigned instance map; modify the 3D representation of the scene based on a depth map associated with the image data; and modify at least one 3D-point identifier to the 3D representation of the scene based on the reassigned instance map.
Aspect 2. The apparatus of aspect 1, wherein: the projected instance map comprises projected identifiers; and the pixel identifiers of the instance map are reassigned to relate to the projected identifiers.
Aspect 3. The apparatus of aspect 2, wherein the pixel identifiers of the instance map are reassigned to relate to the projected identifiers according to a linear-optimization algorithm.
Aspect 4. The apparatus of any one of aspects 2 or 3, wherein the pixel identifiers of the instance map are reassigned to relate to the projected identifiers according to a Hungarian matching algorithm.
Aspect 5. The apparatus of any one of aspects 2 to 4, wherein projected identifiers that are related to a background of the scene are assigned a background identifier.
Aspect 6. The apparatus of any one of aspects 1 to 5, wherein the at least one processor is configured to: determine an identifier mask based on the pixel identifiers of the instance map; wherein the 3D-point identifiers are projected based on the identifier mask.
Aspect 7. The apparatus of any one of aspects 1 to 6, wherein a subset of the 3D-point identifiers are projected based on a subsampling of the 3D-point identifiers.
Aspect 8. The apparatus of any one of aspects 1 to 7, wherein the at least one processor is configured to: process the image data to generate a semantic map, wherein the semantic map includes a semantic label for each pixel of the image data; and modify at least one 3D label of the 3D representation of the scene based on the semantic map.
Aspect 9. The apparatus of aspect 8, wherein the image data is processed to generate the instance map and the semantic map using a segmentation network trained to segment images and assign instance identifiers.
Aspect 10. The apparatus of any one of aspects 1 to 9, wherein the image data is processed to generate the instance map using a segmentation network trained to assign instance identifiers.
Aspect 11. The apparatus of any one of aspects 1 to 10, wherein the 3D representation is iteratively generated according to a volumetric truncated signed distance function (TSDF) fusion technique.
Aspect 12. The apparatus of aspect 11, wherein the 3D representation of the scene is modified based on the depth map according to the volumetric TSDF fusion technique.
Aspect 13. The apparatus of any one of aspects 1 to 12, wherein the at least one processor is configured to generate a 3D mesh based on the 3D representation of the scene, wherein the 3D mesh includes 3D-mesh identifiers based on the 3D-point identifiers.
Aspect 14. The apparatus of aspect 13, wherein the at least one processor is configured to at least one of: render virtual content based on the 3D mesh; store the 3D mesh; or cause at least one transmitter to transmit the 3D mesh.
Aspect 15. A method for generating a three-dimensional (3D) scene representation, the method comprising: processing image data representing a scene to generate an instance map, wherein the instance map includes pixel identifiers for pixels of the image data that represent objects in the scene; projecting, based on a pose associated with the image data, 3D-point identifiers from a 3D representation of the scene to an image plane to generate a projected instance map; reassigning pixel identifiers of the instance map based on the projected instance map to generate a reassigned instance map; modifying the 3D representation of the scene based on a depth map associated with the image data; and modifying at least one 3D-point identifier to the 3D representation of the scene based on the reassigned instance map.
Aspect 16. The method of aspect 15, wherein: the projected instance map comprises projected identifiers; and the pixel identifiers of the instance map are reassigned to relate to the projected identifiers.
Aspect 17. The method of aspect 16, wherein the pixel identifiers of the instance map are reassigned to relate to the projected identifiers according to a linear-optimization algorithm.
Aspect 18. The method of any one of aspects 16 or 17 wherein the pixel identifiers of the instance map are reassigned to relate to the projected identifiers according to a Hungarian matching algorithm.
Aspect 19. The method of any one of aspects 16 to 18, wherein projected identifiers that are related to a background of the scene are assigned a background identifier.
Aspect 20. The method of any one of aspects 15 to 19, further comprising: determining an identifier mask based on the pixel identifiers of the instance map; wherein the 3D-point identifiers are projected based on the identifier mask.
Aspect 21. The method of any one of aspects 15 to 20, wherein a subset of the 3D-point identifiers are projected based on a subsampling of the 3D-point identifiers.
Aspect 22. The method of any one of aspects 15 to 21, further comprising: processing the image data to generate a segmentation map, wherein the segmentation map includes a semantic label for each pixel of the image data; and modifying at least one 3D label of the 3D representation of the scene based on the segmentation map.
Aspect 23. The method of aspect 22, wherein the image data is processed to generate the instance map and the segmentation map using a segmentation network trained to segment images and assign instance identifiers.
Aspect 24. The method of any one of aspects 15 to 23, wherein the image data is processed to generate the instance map using a segmentation network trained to assign instance identifiers.
Aspect 25. The method of any one of aspects 15 to 24, wherein the 3D representation is iteratively generated according to a volumetric truncated signed distance function (TSDF) fusion technique.
Aspect 26. The method of aspect 25, wherein the 3D representation of the scene is modified based on the depth map according to the volumetric TSDF fusion technique.
Aspect 27. The method of any one of aspects 15 to 26, further comprising generating a 3D mesh based on the 3D representation of the scene, wherein the 3D mesh includes 3D-mesh identifiers based on the 3D-point identifiers.
Aspect 28. The method of aspect 27, further comprising at least one of: rendering virtual content based on the 3D mesh; storing the 3D mesh; or transmitting the 3D mesh.
Aspect 29. A non-transitory computer-readable storage medium having stored thereon instructions that, when executed by at least one processor, cause the at least one processor to perform operations according to any of aspects 1 to 28.
Aspect 30. An apparatus for generating a 3D scene representation, the apparatus comprising one or more means for performing operations according to any of aspects 1 to 28.
Aspect 31. An apparatus for generating a 3D scene representation is provided that includes at least one memory and at least one processor (e.g., configured in circuitry) coupled to the at least one memory. The at least one processor configured to perform operations according to any of aspects 1 to 28.

What is claimed is:

1. An apparatus for generating a three-dimensional (3D) scene representation, the apparatus comprising:
at least one memory; and
at least one processor coupled to the at least one memory and configured to:
process image data representing a scene to generate an instance map, wherein the instance map includes pixel identifiers for pixels of the image data that represent objects in the scene;
project, based on a pose associated with the image data, 3D-point identifiers from a 3D representation of the scene to an image plane to generate a projected instance map;
reassign pixel identifiers of the instance map based on the projected instance map to generate a reassigned instance map;
modify the 3D representation of the scene based on a depth map associated with the image data; and
modify at least one 3D-point identifier to the 3D representation of the scene based on the reassigned instance map.

2. The apparatus of claim 1, wherein:
the projected instance map comprises projected identifiers; and
the pixel identifiers of the instance map are reassigned to relate to the projected identifiers.

3. The apparatus of claim 2, wherein the pixel identifiers of the instance map are reassigned to relate to the projected identifiers according to a linear-optimization algorithm.

4. The apparatus of claim 2, wherein the pixel identifiers of the instance map are reassigned to relate to the projected identifiers according to a Hungarian matching algorithm.

5. The apparatus of claim 2, wherein projected identifiers that are related to a background of the scene are assigned a background identifier.

6. The apparatus of claim 1, wherein the at least one processor is configured to:
determine an identifier mask based on the pixel identifiers of the instance map;
wherein the 3D-point identifiers are projected based on the identifier mask.

7. The apparatus of claim 1, wherein a subset of the 3D-point identifiers are projected based on a subsampling of the 3D-point identifiers.

8. The apparatus of claim 1, wherein the at least one processor is configured to:
process the image data to generate a semantic map, wherein the semantic map includes a semantic label for each pixel of the image data; and
modify at least one 3D label of the 3D representation of the scene based on the semantic map.

9. The apparatus of claim 8, wherein the image data is processed to generate the instance map and the semantic map using a segmentation network trained to segment images and assign instance identifiers.

10. The apparatus of claim 1, wherein the image data is processed to generate the instance map using a segmentation network trained to assign instance identifiers.

11. The apparatus of claim 1, wherein the 3D representation is iteratively generated according to a volumetric truncated signed distance function (TSDF) fusion technique.

12. The apparatus of claim 11, wherein the 3D representation of the scene is modified based on the depth map according to the volumetric TSDF fusion technique.

13. The apparatus of claim 1, wherein the at least one processor is configured to generate a 3D mesh based on the 3D representation of the scene, wherein the 3D mesh includes 3D-mesh identifiers based on the 3D-point identifiers.

14. The apparatus of claim 13, wherein the at least one processor is configured to at least one of:
render virtual content based on the 3D mesh;
store the 3D mesh; or
cause at least one transmitter to transmit the 3D mesh.

15. A method for generating a three-dimensional (3D) scene representation, the method comprising:
processing image data representing a scene to generate an instance map, wherein the instance map includes pixel identifiers for pixels of the image data that represent objects in the scene;
projecting, based on a pose associated with the image data, 3D-point identifiers from a 3D representation of the scene to an image plane to generate a projected instance map;
reassigning pixel identifiers of the instance map based on the projected instance map to generate a reassigned instance map;
modifying the 3D representation of the scene based on a depth map associated with the image data; and
modifying at least one 3D-point identifier to the 3D representation of the scene based on the reassigned instance map.

16. The method of claim 15, wherein:
the projected instance map comprises projected identifiers; and
the pixel identifiers of the instance map are reassigned to relate to the projected identifiers.

17. The method of claim 16, wherein the pixel identifiers of the instance map are reassigned to relate to the projected identifiers according to a linear-optimization algorithm.

18. The method of claim 16, wherein the pixel identifiers of the instance map are reassigned to relate to the projected identifiers according to a Hungarian matching algorithm.

19. The method of claim 16, wherein projected identifiers that are related to a background of the scene are assigned a background identifier.

20. The method of claim 15, further comprising:
determining an identifier mask based on the pixel identifiers of the instance map;
wherein the 3D-point identifiers are projected based on the identifier mask.
